(19) United States
(12) Patent Application Publication
(10) Pub. No.: US 2009/0178885 A1
(43) Pub. Date: Jul. 16, 2009

(54) LADDER AND WALKBOARD SUPPORT

(76) Inventor: William J. Heath, Dothan, AL (US)

Correspondence Address: BRUCE E. WEIR, 12 SPARROW VALLEY COURT, MONTGOMERY VILLAGE, MD, 20886-1265, US

(21) Appl. No.: 12/353,319

(22) Filed: Jan. 14, 2009

Related U.S. Application Data
(60) Provisional application No. 61/020,890, filed on Jan. 14, 2008.

(51) Int. Cl. E06C 1/36; E04G 1/34

(52) U.S. Cl. 182/119; 182/206; 182/152

(57) ABSTRACT

A ladder and walkboard support is installed within an open side of a construction scaffold, providing additional support rungs within the open side. The support has upper hooks that hang from an upper scaffold rung and lower saddles that engage the vertical surfaces of a lower scaffold rung, preventing the lower end of the support from swinging when installed. Walkboards may span a pair of supports installed in opposing open sides.

### CROSS-REFERENCE TO RELATED APPLICATION

This application claims the benefit of U.S. provisional patent application Ser. No. 61/020,890, filed by the same inventor on Jan. 14, 2008, now pending.

### BACKGROUND

Scaffold frames are widely used in the construction trades to provide workers with easy access to the entire surface areas of walls. Horizontal rungs on a scaffold frame support walkboards that bear the weight of a worker with tools and materials. The most commonly used open scaffold frame has three vertical supports on each end, with rungs at only two height positions at an “open” side and rungs at four height positions on a “closed” side. Workers typically use the rungs on the “closed” side to support walkboards because the top rung on the open side is too high and the bottom rung too low for safe, productive use. These limitations on walkboard position may require that the scaffold be repeatedly torn down and restaged, reducing productivity and increasing possibilities for mishaps.

### SUMMARY

Additional support rungs may be added to the “open” sides of construction scaffolds by installing walkboard supports that hook onto upper scaffold rungs on an open side and are prevented from swinging by saddles that engage lower scaffold rungs. Ladder rungs within the walkboard support may be used for ascending a scaffold. Pairs of walkboard supports attached to opposing open sides may be used to add walkboards that span the ladder rungs within the open sides, allowing users to add more space to a work area in convenient position, reducing the amount of reaching and lifting a worker must do and the number of trips to the ground for additional tools and materials. All of these features and advantages of the present invention, and more, are illustrated below in the drawings and detailed description that follow.

### BRIEF DESCRIPTION OF THE DRAWINGS

FIG. 1 shows a perspective view of a ladder and walkboard support being installed in a construction scaffold.

FIG. 2 shows a perspective view of a ladder and walkboard support installed in a construction scaffold supporting additional walkboards.

FIG. 3 shows a front elevational view of a ladder and walkboard support.

FIG. 4 shows a side elevational view of a ladder and walkboard support.

FIG. 5 shows a perspective view of a security pin being installed in a hook.

FIG. 6 shows a perspective view of a security pin installed in a hook.

### DETAILED DESCRIPTION

In the Summary above and in the Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps that are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number) (a second number),” this means a range whose lower limit is the first number and whose upper limit is the second number. For example, 25 to 100 mm means a range whose lower limit is 25 mm, and whose upper limit is 100 mm.

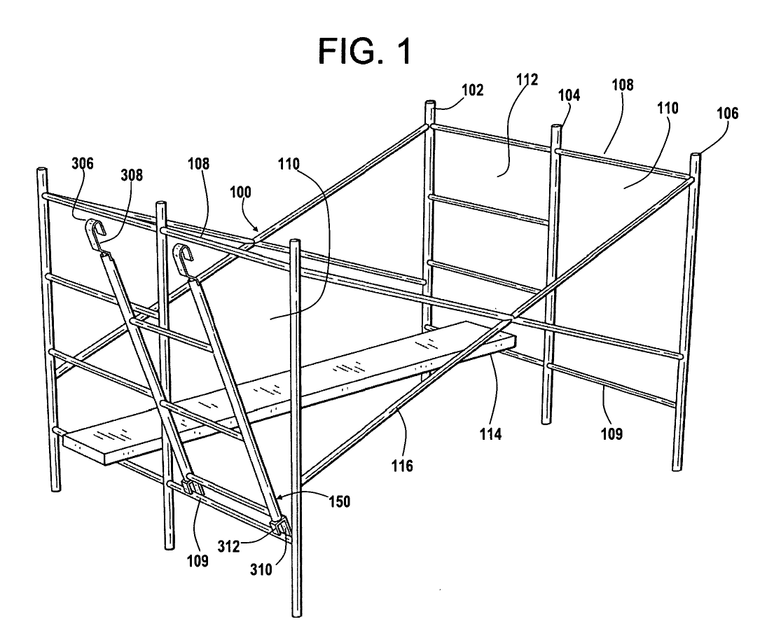

A ladder and walkboard support that comprises an embodiment of the present invention provides users with a simple and safe way to add rungs to the “open” side of a scaffold frame. As shown in FIG. 1, a typical scaffold frame 100 as is known in the art is generally rectangular with at least a first vertical post 102, a second vertical post 104, and a third vertical post 106 comprising each end of the frame. The vertical posts on each end are joined by at least an upper horizontal scaffold rung 108 and a lower horizontal scaffold rung 109. The second and third posts 104, 106 are joined by two scaffold rungs, creating an open side 110 of the scaffold through which a person can easily step to reach the interior of the scaffold. The first and second posts 102, 104 are joined by more than two scaffold rungs, creating a closed side 112 of the scaffold that can support one or more walkboards 114 at several levels. The ends of the scaffold frame mirror one another and are joined by struts 116.

At least one walkboard 114 spans the ends of the scaffold, resting at each end of the walkboard on a scaffold rung at the same level, creating a long, level platform on which a worker can stand and rest tools and materials. In practice, workers often prefer to have several walkboards on which to rest tools and materials at levels that minimize the need for bending and reaching. Disadvantageously, the widely-spaced scaffold rungs 108, 109 on the open side 110 of the scaffold limit their choices to too high and too low.

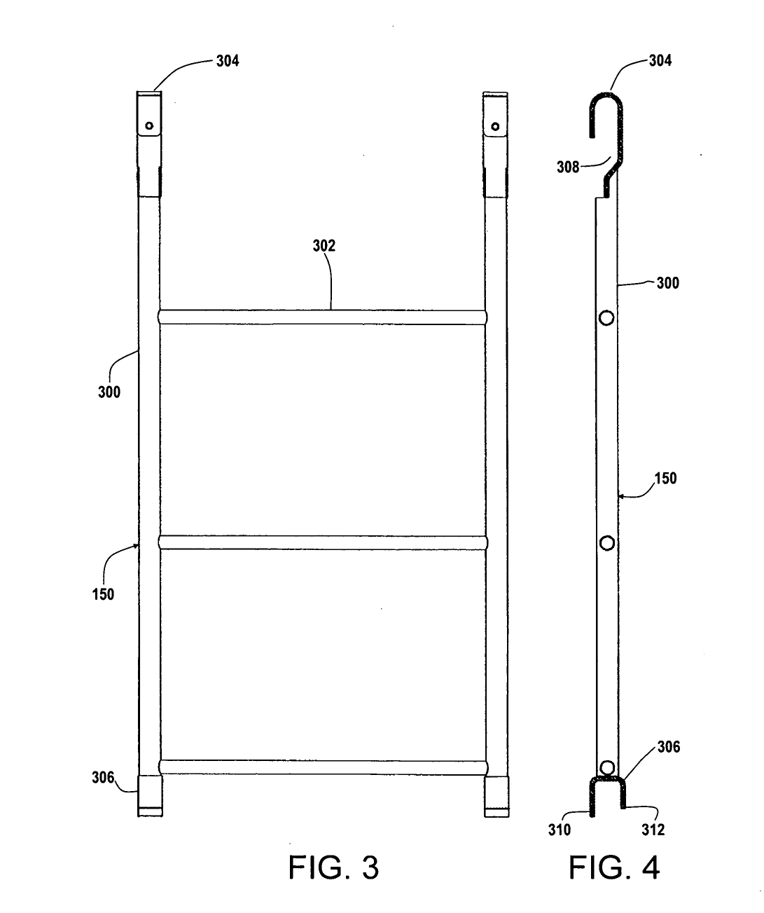

More convenient intermediate rungs can be quickly and safely added with a ladder and walkboard support 150 that attaches easily to the scaffold 100. As shown in FIG. 3, an embodiment of such a ladder and walkboard support 150 comprises two vertical members 300 joined by at least two horizontal ladder rungs 302. A hook 304 at the top of each vertical member and a saddle 306 at the bottom of each vertical member are sized and shaped to engage scaffold rungs.

As shown in FIG. 4, each hook 304 is preferably formed and attached to a vertical member 300 so that the hook 304 is centered with respect to the central axis of the vertical member 300. Each hook 304 has a lower throat portion 308 that is horizontally open on one side to allow a user to move the hook 304 horizontally against a scaffold rung, then drop the ladder and walkboard support 150 straight down to engage the scaffold rung. Centering the hook with respect to the central axis of the vertical member minimizes the tendency of the ladder and walkboard support to swing when suspended from a scaffold rung and weighted by a walkboard.

Each saddle 306 is also preferably centered with respect to the central axis of a vertical member 300. Each saddle has two arms extending downward to engage a scaffold rung and prevent the lower end of the ladder and walkboard support from swinging when mounted on a scaffold. A first saddle arm 310 preferably extends downward further than a second saddle arm 312 and is preferably oriented to the side of the ladder and walkboard support 150 to which the throat 308 of the corresponding hook 306 opens.

The ladder and walkboard support 150 may be constructed from a variety of known materials but is preferably made from steel or other materials similar to those used in a scaffold, using well-known manufacturing methods.

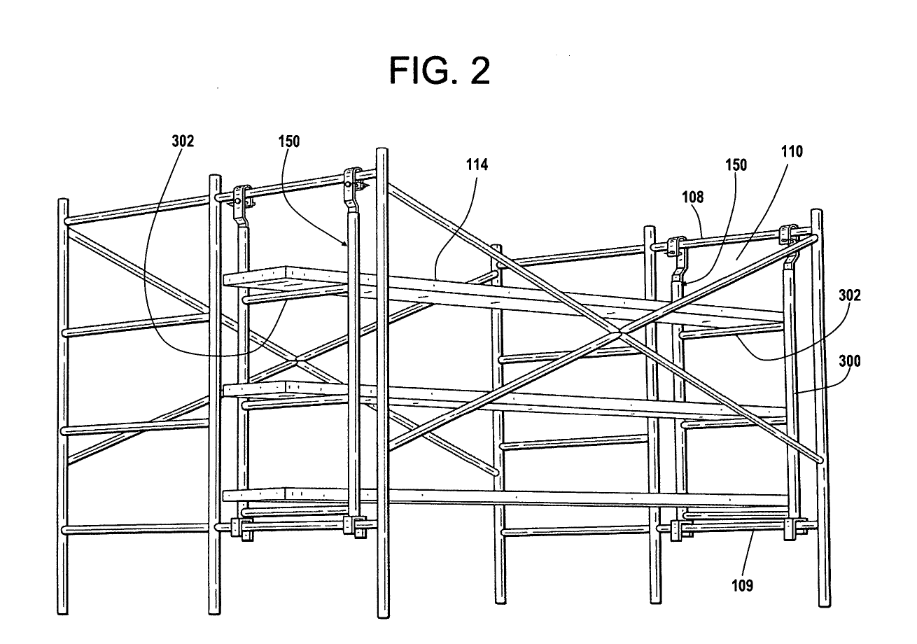

Returning to FIG. 1, a user attaches a ladder and walkboard support 150 to a scaffold 100 by resting the inner surfaces of the tips of the first saddle arms 310 against a lower scaffold rung 109 in an open side 110, pivoting the ladder and walkboard support 150 about the lower scaffold rung 109 while swinging the hooks 306 toward the upper scaffold rung 108 until the upper scaffold rung 108 passes through the throat 308 of each hook 306, then dropping the ladder and walkboard support 150 downward until the hooks 306 hang from the upper scaffold rung 108 and the lower scaffold rung 109 rests between the first and second saddle arms 310, 312 in the manner shown in FIG. 2. The lengths of the vertical members 300 are chosen so that the hooks 304 and saddles 306 will fully engage upper and lower scaffold rungs 108, 109 when the ladder and walkboard support 150 is installed. The ladder and walkboard support 150 may be installed in this fashion from outside or inside a scaffold frame.

As shown in FIG. 2, a second ladder and walkboard support 150 may be installed in the opposite open side 110, providing a means for supporting walkboards 114 on intermediate ladder rungs 302. Each ladder and walkboard support may also serve as a ladder to allow workers to ascend a tall scaffold.

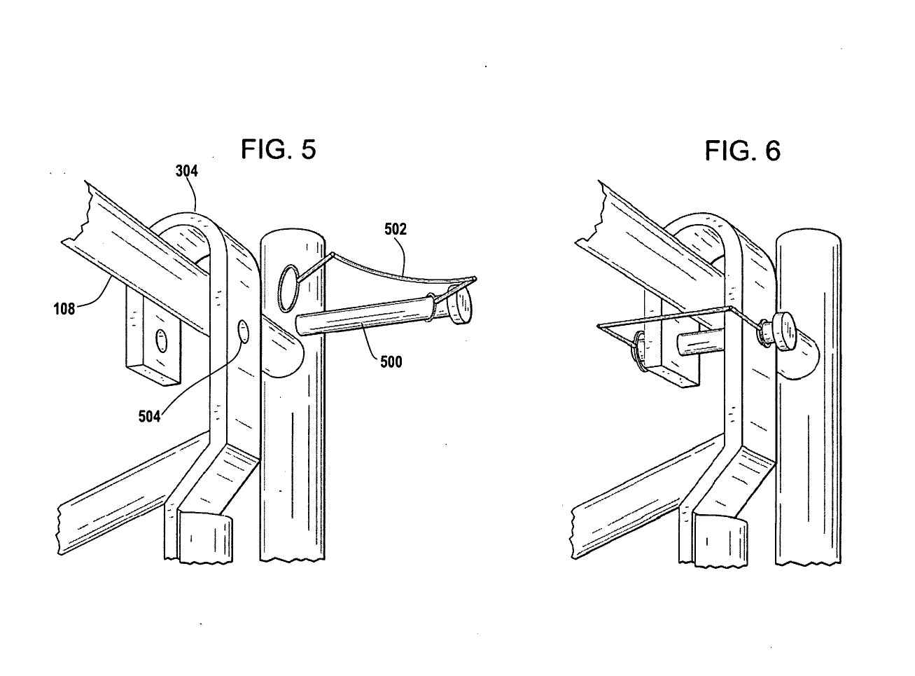

Although weight tends to lock an installed ladder and walkboard support in place, an installed ladder and walkboard support may be further secured with security pins. FIG. 5 shows a pin 500 with an attached retainer 502. Once a hook 304 is suspended from an upper scaffold rung 108, the retainer 502 is bent to allow the pin 500 to pass through holes 504 in the hook 304 that are positioned below the scaffold rung 108. The retainer 502 is then allowed to return to its normal form and is hooked around the free end of the pin 500 in the manner shown in FIG. 6. For clarity, FIGS. 2, 5, and 6 show hooks separated from engaged upper rungs, but in use each hook would be contacting and suspended from a rung when installed.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

I claim:

1. A ladder and walkboard support, comprising:
a first vertical member and a second vertical member;
at least a first rung and a second rung, the first and second rungs substantially orthogonal to the vertical members and joining the vertical members, the first and second vertical members horizontally separated by at least enough distance to admit a walkboard between them;
a first hook and a second hook, the first and second hooks sized and shaped to engage and hang from a scaffold rung, the first hook attached to the upper end of the first vertical member, the second hook attached to the upper end of the second vertical member; and
a first saddle and a second saddle, the first saddle attached to the lower end of the first vertical member and the second saddle attached to the lower end of the second vertical member, each saddle comprising a first saddle arm and a second saddle arm, the saddle arms projecting downward with respect to the vertical members, the first saddle arms being longer than the second saddle arms, the saddle arms that comprise each saddle being separated by a distance sufficient to make the saddle fit closely around vertically-oriented surfaces of a scaffold rung, the hook and saddle attached to each vertical member being separated by a distance that allows the saddle attached to a vertical member to engage a lower scaffold rung while the hook attached to the same vertical member is hooked to an upper scaffold rung.

2. A ladder and walkboard support as claimed in claim 1, further comprising a security pin with a retainer, the security pin operable to pass through holes in a hook to prevent the hook from being detached from a scaffold rung within the hook, the retainer operable to prevent the inserted pin from being removed from the holes.

3. A system for supporting walkboards within a construction scaffold, comprising:
a construction scaffold with at least a first open side and a second open side, the second open side positioned laterally opposite and parallel to the first open side, each open side having a horizontal upper scaffold rung and a horizontal lower scaffold rung;
a first ladder and a second ladder, each ladder operable to attach to and hang between the upper and lower scaffold rungs of an open side, each ladder having a first vertical member and a second vertical member, each ladder further having at least a first ladder rung and a second ladder rung, the first and second ladder rungs being substantially horizontal and joining the vertical members, the first and second vertical members horizontally separated by at least enough distance to admit a walkboard between them, each ladder further having a first hook and a second hook, the first and second hooks sized and shaped to engage and hang from an upper scaffold rung, the first hook attached to the upper end of the first vertical member, the second hook attached to the upper end of the second vertical member, each ladder further having a first saddle and a second saddle, the first saddle attached to the lower end of the first vertical member and the second saddle attached to the lower end of the second vertical member, each saddle comprising a first saddle arm and a second saddle arm, the saddle arms projecting downward with respect to the vertical members, the first saddle arms being longer than the second saddle arms, the saddle arms that comprise each saddle being separated by a distance sufficient to make the saddle fit closely around vertically-oriented surfaces of a lower scaffold rung, the hook and saddle attached to each vertical member being separated by a distance that allows the saddle attached to a vertical member to engage the lower construction scaffold rung while the hook attached to the same vertical member is hooked to the upper construction scaffold rung; and
at least a first walkboard, the walkboard operable to span and rest upon ladder rungs in ladders attached to first and second open sides.

4. A system for supporting walkboards within a construction scaffold as claimed in claim 3, further comprising a security pin with a retainer, the security pin operable to pass through holes in a hook to prevent the hook from being detached from a scaffold rung within the hook, the retainer operable to prevent the inserted pin from being removed from the holes.

5. A method for installing a walkboard support within a construction scaffold, comprising:
placing the inner surfaces of the tips of the longest saddle arms of saddles attached to the lower ends of a walkboard support against a lower scaffold rung in an open side of a construction scaffold;
pivoting the walkboard support about the lower scaffold rung while swinging hooks attached to the upper ends of the walkboard support toward an upper scaffold rung until the upper scaffold rung passes through an opening below each hook; and
dropping the walkboard support until the hooks hang from the upper scaffold rung and the lower scaffold rung rests within the saddle arms.

6. A method for installing a walkboard support within a construction scaffold as claimed in claim 5, further comprising affixing each hook to the upper scaffold rung with a security pin.
